(19) United States
(12) Patent Application Publication
(10) Pub. No.: US 2012/0260034 A1
(43) Pub. Date: Oct. 11, 2012

(54) DISK ARRAY APPARATUS AND CONTROL METHOD THEREOF

(75) Inventors: Zaki Primadani, Fujisawa (JP); Xiaoming Jiang, Odawara (JP); Takashi Fukushima, Odawara (JP)

(73) Assignee: Hitachi, Ltd.

(21) Appl. No.: 13/125,305

(22) PCT Filed: Apr. 6, 2011
(86) PCT No.: PCT/JP2011/002057

§ 371 Date: May 2, 2011

(51) Int. Cl. G06F 12/00; G06F 12/08

(52) U.S. Cl. 711/113; 711/114; 711/E12.001; 711/E12.019

(57) ABSTRACT

Proposed are a disk array apparatus and a control method thereof which facilitate data processing such as write processing and read processing even if the block sizes handled by a host computer are different.

If a first write command is received from the host computer, the controller of the disk array apparatus divides first write data into a plurality of second write data, and adds a first guarantee code and writes this data to the plurality of first storage devices; if a first read command is received from the host computer, the controller reads a plurality of first read data from the plurality of first storage devices, generates second read data which is obtained by combining [the plurality of first read data], and adds a second guarantee code [to the second read data] and transmits this data to the host computer; if a second write command is received from the host computer, the controller generates fourth write data based on third write data, adds a third guarantee code [to the fourth write data] and writes this data to the plurality of second storage devices and, if the second read command is received from the host computer, the controller reads third read data from the plurality of second storage devices, divides this data into fourth read data, and adds a fourth guarantee code and transmits the data to the host computer

### TECHNICAL FIELD

The present invention relates to a disk array apparatus and a control method thereof and in particular is suitably applied to a disk array apparatus to which data is read and written by a host computer of a different data handling size (block size).

### BACKGROUND ART

Conventionally, in a disk array apparatus, data redundancy technology known as RAID (Redundant Array of Inexpensive Disks) is adopted in order to prevent data loss due to storage device failure or the like. In a disk array apparatus adopting data redundancy technology, a RAID group is configured from a plurality of storage devices (hard disk devices, for example), and logical storage areas (hereinafter called &apos;logical volumes') are formed in physical storage areas provided by the plurality of storage devices forming the same RAID group. Furthermore, the data from the host computer are read and written from/to the logical volumes in units which are blocks of a predetermined size.

Incidentally, this RAID technology is technology which is used in the event that a portion of the data cannot be read from a storage device due to the storage device failing, or similar, however RAID technology is unable to tackle faults where, for example, after a disk array apparatus receives data from a host computer, the content of the data changes in the period up until the data is written to the storage device.

In order to tackle this fault, PTL1, for example, discloses a method whereby, in the disk array apparatus, if a write request and write data are received from the host computer, the data is stored in a storage device after adding redundancy information called ‘guarantee code’ to this data, whereas if a data read request is received, the data is read from the storage device together with the guarantee code and the validity of the read data is checked based on the guarantee code thus read.

However, the size of all the data increases to the same degree that the guarantee code is added to the data as mentioned above and therefore, if either the storage device or the host computer does not support the guarantee code (is not compatible with the guarantee code), the host computer is sometimes unable to read or write data from/to the disk array apparatus since data sizes handled by the host computer and disk array apparatus differ.

As means for solving this problem, PTL2, for example, discloses a method for sending and receiving data, between a host computer and disk array apparatus, using the size of the least common multiplier of the data handling size handled by the host computer and the data handling size handled by the disk array apparatus.

Furthermore, PTL3, for example, discloses a method in which data is handled in the disk array apparatus as data which is a plural multiple of the data handling size by reading and writing using a data size which is obtained by adding gap data to data which is a plural multiple of the data handling size in the host computer.

### CITATION LIST

### Patent Literature

PTL 1: Japanese Published Unexamined Application No. 2006-079380
PTL 2: Japanese Published Unexamined Application No. 2006-195851
PTL 3: Japanese Published Unexamined Application No. 2009-129201

### SUMMARY OF INVENTION

### Technical Problem

It is assumed in PTL1, PTL2, and PTL3 that the block size handled by the host computer is the same as the block size of the storage devices. Hence, even if conventional technology is used, in cases where the block size handled by the host computer is different from the block size of the storage devices, there is a problem in that the disk array apparatus is unable to transfer data and is unable to execute read or write processing.

The present invention was devised in view of the foregoing problem and proposes a method whereby the disk array apparatus is able to suitably execute data processing such as write processing and read processing even if there is a difference between the block size handled by the host computer and the block size of the storage devices.

### Solution to Problem

In order to achieve the foregoing object, the present invention provides a disk array apparatus, comprising a plurality of first storage devices which store data; and a controller which controls data I/Os to and from the plurality of first storage devices, wherein, if a first write command is received from the host computer, the controller divides the first write data related to the first write command into a plurality of second write data, adds a first guarantee code to each of the plurality of second write data and writes the data to the plurality of first storage devices or, if a first read command is received from the host computer, the controller reads a plurality of first read data related to the first read command from the plurality of first storage devices, generates second read data obtained by combining the plurality of first read data, and adds a second guarantee code to the second read data and transmits the data to the host computer.

Further, the present invention provides a data array apparatus, further comprising a plurality of second storage devices which store data, wherein, if a second write command is received from the host computer, the controller generates fourth write data based on third write data related to the second write command and adds a third guarantee code to the fourth write data and writes this data to the plurality of second storage devices, wherein, if a second read command is received from the host computer, the controller reads third read data related to the second read command from the plurality of second storage devices, divides the third read data into a plurality of fourth read data, and adds a fourth guarantee code to each of the plurality of fourth data and transmits this data to the host computer.

Furthermore, the present invention provides a control method of a disk array apparatus which comprises a plurality of first storage devices which store data, and a controller which controls data I/Os to and from the plurality of first storage devices, the control method comprising a first step in which the controller receives a first write command or a first read command from the host computer; and a second step in which the controller divides the first write data related to the first write command into a plurality of second write data according to the first write command, adds a first guarantee code to each of the plurality of second write data and writes the data to the plurality of first storage devices or, according to the first read command, reads a plurality of first read data related to the first read command from the plurality of first storage devices, generates second read data obtained by combining the plurality of first read data, and adds a second guarantee code to the second read data and transmits the data to the host computer.

### Advantageous Effects of Invention

The present invention makes it possible for the disk array apparatus to suitably execute data processing such as write processing and read processing even if there is a difference between the block size handled by the host computer and the block size of the storage devices

### BRIEF DESCRIPTION OF DRAWINGS

FIG. 1 is a block diagram showing the overall configuration of a computer system according to first and second embodiments.

FIG. 2A is a conceptual view showing a data configuration of data handled by a host computer, FIG. 2B is a conceptual view showing a data configuration of data handled in a disk array apparatus, and FIG. 2C is a conceptual view showing a guarantee code data configuration.

FIG. 3 is a conceptual view illustrating a block size conversion function according to this embodiment.

FIG. 4 is a conceptual view illustrating a block size conversion function according to this embodiment.

FIG. 5 is a conceptual view showing the configuration of an LBA conversion table according to first and third embodiments.

FIG. 6 is a flowchart showing a processing routine for write processing according to the first embodiment.

FIG. 7 is a conceptual view illustrating read modify write processing according to the first and third embodiments.

FIG. 8 is a flowchart showing a processing routine for read processing according to the first embodiment.

FIG. 9 is a conceptual view showing the configuration of an LBA conversion table according to the second and fourth embodiments.

FIG. 10 is a flowchart showing a processing routine for write processing according to the second embodiment.

FIG. 11 is a flowchart showing a processing routine for read processing according to the second embodiment.

FIG. 12 is a block diagram showing the overall configuration of a computer system according to third and fourth embodiments.

FIG. 13 is a flowchart showing a processing routine for write processing according to the third embodiment.

FIG. 14 is a flowchart showing a processing routine for read processing according to the third embodiment.

FIG. 15 is a flowchart showing a processing routine for write processing according to the fourth embodiment.

FIG. 16 is a flowchart showing a processing routine for read processing according to the fourth embodiment.

### DESCRIPTION OF EMBODIMENTS

Embodiments of the present invention are explained in detail hereinbelow with reference to the drawings.

### (1) First Embodiment

### (1-1) Configuration of Computer System According to this Embodiment

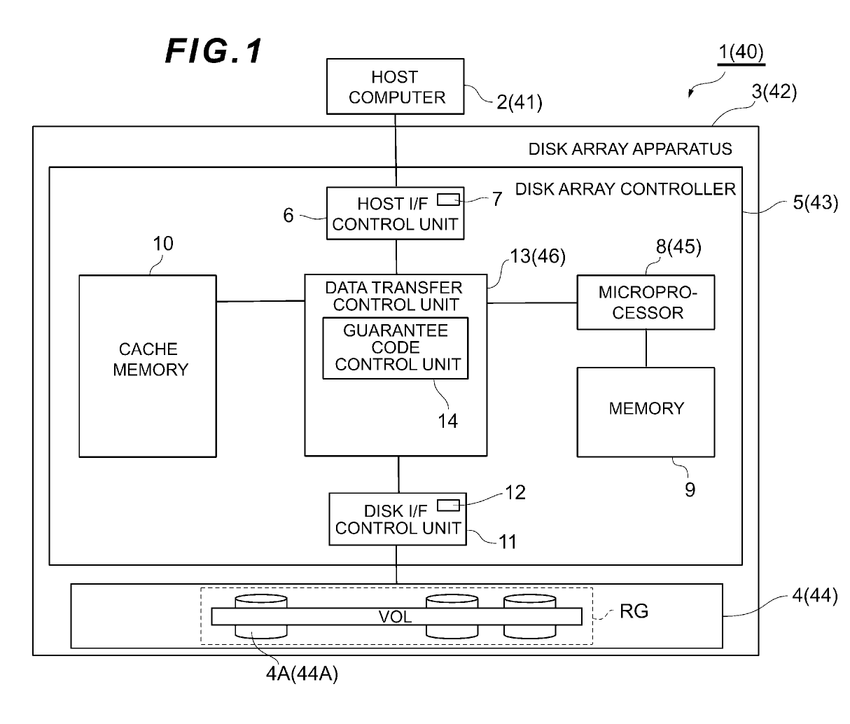

In FIG. 1, 1 indicates the whole computer system according to this embodiment. This computer system 1 is configured comprising a host computer 2 and a disk array apparatus 3. The host computer 2 and disk array apparatus 3 are connected via an FC (Fibre Channel) network or other network. FIG. 1 features only one host computer 2 but the embodiment is not limited thereto, rather, a plurality of host computers may be connected to the disk array apparatus 3. The block size with which data is handled may be different for each host computer 2 (may be 4 kilobytes or 512 bytes, for example). Furthermore, the block size with which data is handled may also be different for each application executed by the controller of the host computer 2.

The host computer 2 is a computer device comprising information processing resources such as a CPU (Central Processing Unit) and memory and is configured from a personal computer, workstation, or mainframe or the like, for example.

The disk array apparatus 3 is configured comprising a storage device unit 4 comprising one or more storage devices 4A, and a disk array controller 5 which controls data I/Os to and from the storage device unit 4. There may be a mixture of storage devices 4A, namely a storage device 4A in which a 4-kilobyte block size is the data handling size, for example, and a storage device 4A in which a 512-kilobyte block size is the data handling size, for example. Alternatively, only the storage device 4A in which a 4-kilobyte block size is the data handling size may be installed. Further, only the storage device 4A in which a 512-kilobyte block size is the data handling size may be installed.

The storage devices 4A are each configured, for example, from high-cost disks such as SCSI (Small Computer System Interface) disks or low-cost disks such as SATA (Serial AT Attachment) disks and optical disks.

A RAID group RG is configured from one or more storage devices 4A and one or more logical volumes VOL are defined in a physical storage area provided by each of the storage devices 4A forming a single RAID group RG. Furthermore, the data from the host computer 2 is stored in the logical volume VOL in units which are blocks (hereinafter called ‘logical blocks’) of a predetermined size.

A unique identifier (hereinafter called a ‘LUN’ (Logical Unit Number)) is assigned to each of the logical volumes VOL. In the case of this embodiment, data I/Os are executed by creating addresses by combining the LUN with a unique number (hereinafter called the LBA (Logical Block Address)) assigned to each logical block and designating the relevant address.

The disk array controller 5 is configured comprising a host interface control unit 6, a microprocessor 8, a memory 9, a cache memory 10, a disk interface control unit 11, and a data transfer control unit 13 which mutually connects these components [of the disk array controller 5].

The host interface control unit 6 is an interface which executes protocol control during communications with the host computer 2 and is configured comprising a guarantee code control circuit 7. The guarantee code control circuit 7 executes processing to check that there are no errors in the write data on the basis of the guarantee code assigned to the write data transmitted from the host computer 2 as described subsequently, and add the guarantee code to the read data which is transmitted to the host computer 2, and so on.

The microprocessor 8 is a processor which governs operational control of the whole disk array apparatus 3. The microprocessor 8 performs communication with and exchanges various commands with the host computer 2 via the data transfer control unit 6 and the host interface control unit 13.

The memory 9 is configured from a semiconductor memory such as DRAM (Dynamic Random Access Memory), for example, and, in addition to being used to store various control programs and various control information and the like, is also used as the working memory of the microprocessor 8. Various processing of the whole disk array apparatus 3 is executed as a result of the microprocessor 8 executing the control programs stored in the memory 9.

The cache memory 10 is configured from a volatile memory or the like which is backed up by an involatile memory or battery, for example, and is used to temporarily store write data which is transmitted from the host computer 2 and read data which is read from the logical volume VOL.

The disk interface control unit 11 is an interface which performs protocol control when data is read and written from/to the storage devices 4A and is configured comprising a guarantee code control circuit 12. The guarantee code control circuit 12 checks that there are no errors in the write data and read data on the basis of the write data which is read and transferred from the cache memory 10 by a data transfer control unit 13, described subsequently, and the guarantee code which is added to the read data read from the storage devices 4A.

The data transfer control unit 13 is an ASIC (Application Specific Integrated Circuit) which, according to instructions from the microprocessor 8, performs data transfers between the host interface control unit 6, the microprocessor 8, the cache memory 10, and the disk interface control unit 11. The data transfers between the host interface control unit 6, the microprocessor 8, the cache memory 10, and the disk interface control unit 11 are executed via the data transfer control unit 13.

### (1-2) Block Size Conversion Function According to this Embodiment

A block size conversion function which is installed in the disk array apparatus according to this embodiment is explained next. In so doing, the units for handling the data (block size) in the host computer 2 and disk array apparatus 3 are explained first.

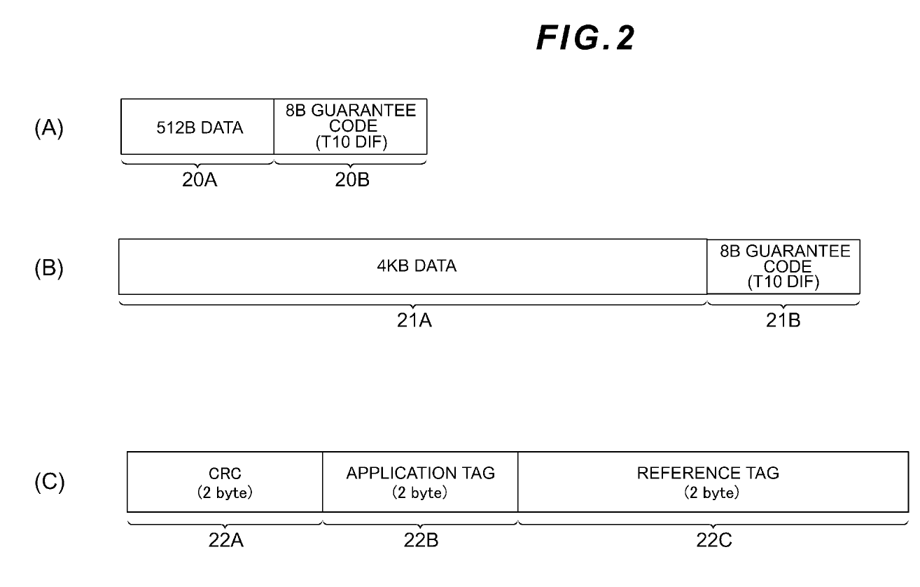

FIG. 2A shows a data configuration of data (write data) which is transferred from the host computer 2 to the disk array apparatus 3 together with a write command. In the case of this embodiment, the block size of the host computer 2 is 512 bytes, and every 512 bytes of data (hereinafter called ‘512 byte data’) 20A is transferred from the host computer 2 to the disk array apparatus 3. Here, if the host computer 2 supports the guarantee code, the host computer 2 adds an 8-byte guarantee code 20B to every 512 bytes of data 20A.

Furthermore, FIG. 2B shows the data configuration of data handled in the disk array apparatus 3. In the case of this embodiment, the block size of data in the disk array apparatus 3 is 4 kilobytes and an 8 byte guarantee code 21B is added to these 4 kilobytes of data (hereinafter called ‘4 kilobyte data’) 21A, [the data] is transferred between the host interface control unit 6, the microprocessor 8, the cache memory 10, and the disk interface control unit 11 and read and written from/to the storage devices 4A. Note that 4 kilobytes is a size equivalent to one logical block of the logical volume VOL provided by the RAID group.

FIG. 2C shows a specific example of guarantee codes 20B, 21B which are added to the data as per FIGS. 2A and 2B. As is also clear from FIG. 2C, with this embodiment, the guarantee codes 20B, 21B are configured from two bytes of CRC (Cyclic Redundancy Check) data 22A, similarly two bytes of application tag data 22B, and four bytes of reference tag data 22C.

Among this data, the CRC data 22A is an error detection symbol which is calculated by carrying out an exclusive-OR calculation on the data. The application tag data 22B is an error detection symbol which is calculated by executing an exclusive-OR calculation on the LUN of the logical volume serving as the access destination (write destination or read destination) of the corresponding data, and the reference tag data 22C is an error correction symbol which is calculated by executing an exclusive-OR calculation on the LBA of the access destination in the logical volume VOL.

As described hereinabove, in this computer system 1, the block size of the data in the host computer 2 is 512 bytes, whereas the block size of the data in the disk array apparatus 3 is 4 kilobytes, and 512 byte data 20A which is transmitted from the host computer 2 to the disk array apparatus 3 cannot be handled by the disk array apparatus 3 in its existing size.

Therefore, in the case of this embodiment, the disk array apparatus 3 contains a block size conversion function which transmits each of the 4-kilobyte data 21A read from the storage device 4A to the host computer 2 after converting this data into eight portions of 512 byte data 20A while writing to the corresponding logical block in the logical volume VOL after converting the data to the 4-kilobyte data 21A by integrating, eight packets at time, each of the 512 byte data 20A transmitted from the host computer 2.

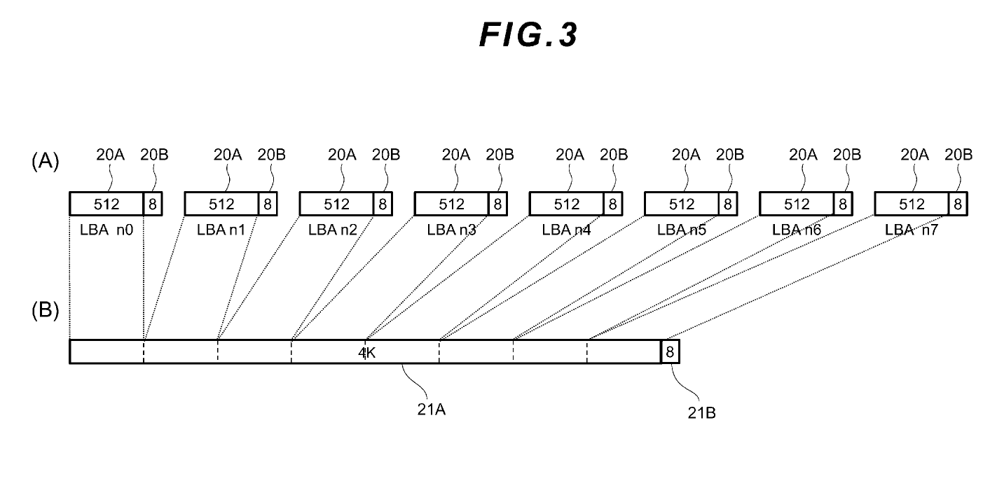

In reality, upon receiving the write command transmitted from the host computer 2 and one or more 512 byte data 20A as shown in FIG. 3A, the disk array apparatus 3 stores these 512 byte data 20A sequentially in the cache memory 10. Thereupon, if the host computer 2 does not support guarantee codes, the guarantee code 20B is added to each of the 512 byte data.

Furthermore, as shown in FIG. 3B, the disk array apparatus 3 subsequently generates 4-kilobyte data 21A in sequence by integrating, eight packets at time and in order of transfer, the 512 byte data 20A stored in the cache memory 10 and, after adding the guarantee code 21B calculated on the basis of each of the 4-kilobyte data 21A, the 4-kilobyte data 21 are each written to the corresponding logical blocks in the logical volume VOL designated in the write command.

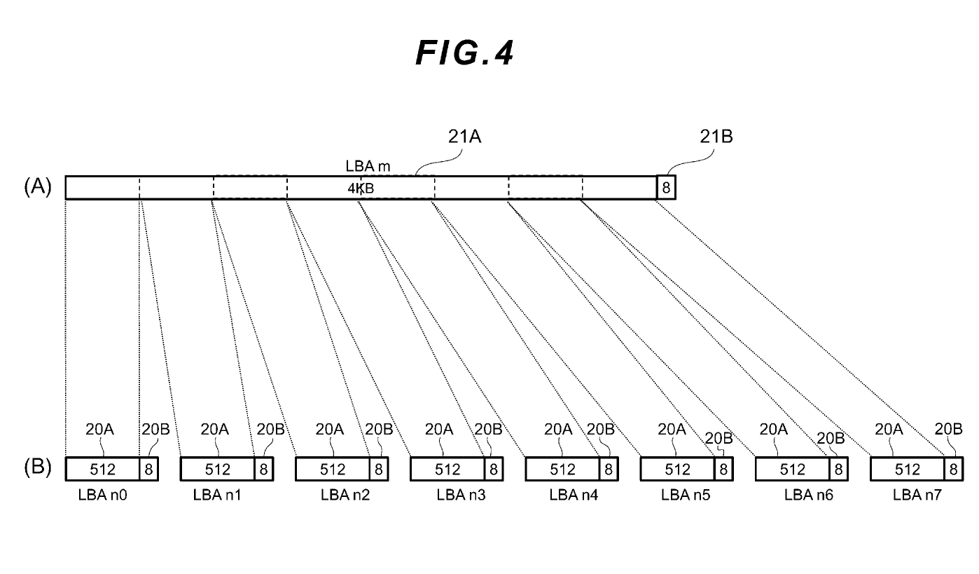

Meanwhile, when a read command is supplied from the host computer 2, the disk array apparatus 3 reads the required number of 4-kilobyte data 21A (FIG. 4A) and guarantee codes 21B from the corresponding logical blocks in the logical volume VOL designated in the read command and stores the 4-kilobyte data 21A and the guarantee code 21B in the cache memory 10.

Further, as shown in FIG. 4B, the disk array apparatus 3 divides each of the 4-kilobyte data 21A stored in the cache memory 10 into eight 512 byte data 20A, transmits these eight 512 byte data 20A to the host computer 2. Here, if the host computer 2 supports the guarantee code, the disk array apparatus 3 transmits each of the 512 byte data 20A after adding a new guarantee code 20B which is calculated on the basis of each of these 512 byte data 20A.

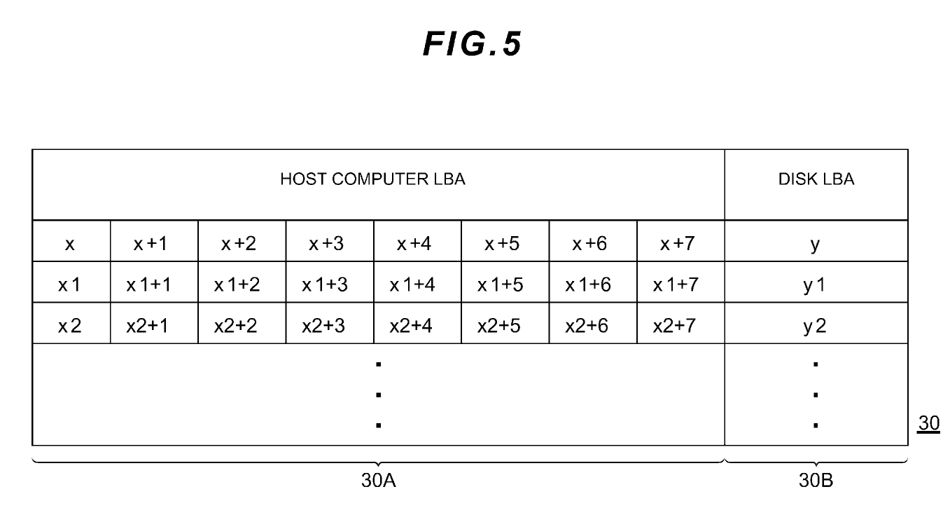

As means for executing the foregoing block size conversion processing according to this embodiment, the memory 9 of the disk array controller 5 of the disk array apparatus 3 stores an LBA conversion table 30 as shown in FIG. 5.

The LBA conversion table 30 is a table which is used to manage the correspondence relationships between the LBA which are recognized by the host computer 2 of the logical volume VOL, and the actual LBA. That is, according to this embodiment, the host computer 2 recognizes the storage areas in the logical volumes VOL provided by the disk array apparatus 3 in 512 byte units but the storage areas in the logical volumes VOL in the disk array apparatus 3 are managed in 4-kilobyte units (that is, 4-kilobyte logical block units). Accordingly, the disk array apparatus 3 manages the correspondence relationships between the LBA recognized by the host computer 2 and the LBA managed by the disk array apparatus 3 using the LBA management table 30. Therefore, the LBA management table 30 is created for each of the logical volumes VOL.

The LBA conversion table 30 is, as shown in FIG. 5, configured from a host computer LBA field 30A and a disk LBA field 30B. Further, the disk LBA field 30B stores LBA (hereinafter called ‘disk LBA’) which are assigned to each storage area (logical block) of every 4 kilobytes in the corresponding logical volume VOL and the host computer LBA field 30A stores, for these storage areas, each of the LBA (hereinafter called ‘host LBA’) of eight logical blocks recognized by the host computer 2.

Therefore, FIG. 5 shows, for example, that hosts LBA ‘x’ to ‘x+7’ correspond to the disk LBA ‘y’, the hosts LBA ‘x1’ to ‘x1+7’ correspond to the disk LBA ‘y1’, and the hosts LBA ‘x2’ to ‘x2+7’ correspond to the disk LBA ‘y2’.

Accordingly, if a write command in which the LBA ‘x’ to ‘x+6’ or ‘x+7’ in the corresponding logical volume VOL is the write destination is supplied to the disk array apparatus 3 by the host computer 2, the data is written to the logical block which has been assigned the LBA ‘y’ in the logical volume VOL. Furthermore, if a read command in which the LBA ‘x1’ to ‘x1+6’ or ‘x1+7’ in the corresponding logical volume VOL is the read destination is supplied to the disk array apparatus 3 by the host computer 2, the data is read from the logical block which has been assigned the LBA ‘y1’ in the logical volume VOL.

### (1-3) Write Processing According to this Embodiment

The specific processing content of the write processing which is executed in the disk array apparatus 3 will be described next.

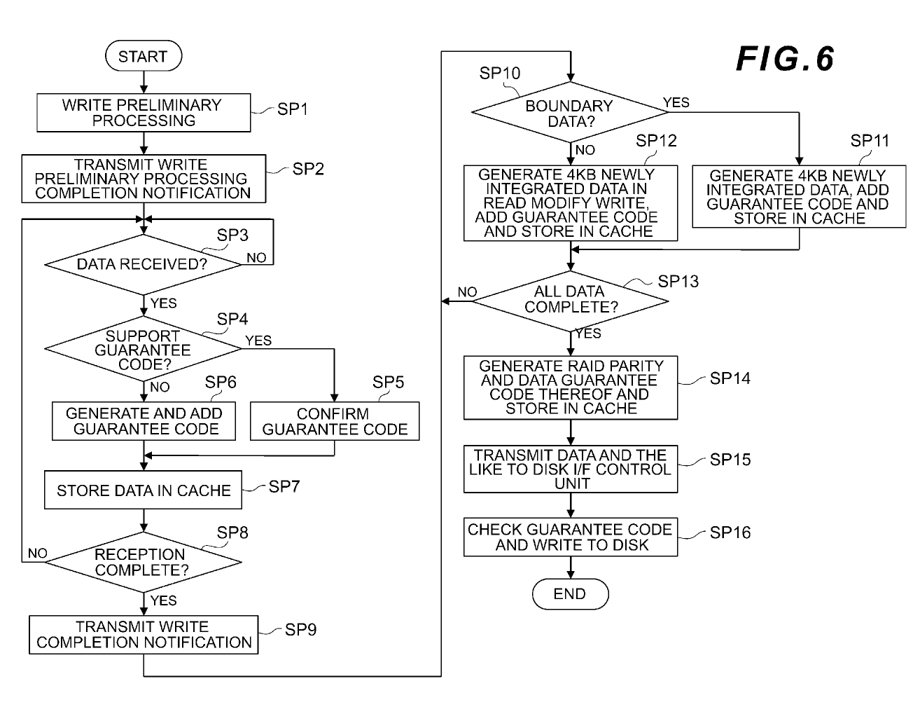

FIG. 6 shows a processing routine for write processing which is executed by the microprocessor 8 of the disk array apparatus 3 which receives the write command from the host computer 2.

Upon receiving the write command which is issued by the host computer 2 via the host interface control unit 6, the microprocessor 8 starts the write processing and first executes predetermined preliminary processing (hereinafter called ‘write preliminary processing’) for writing write data to the logical volume VOL (SP1).

More specifically, the microprocessor 8 reserves a storage area for temporarily storing the write data transmitted from the host computer 2 in the cache memory 10. Furthermore, the microprocessor 8 refers to the LBA conversion table 30 and, by converting the LBA designated as the write-data write destination in the write command into the corresponding LBA in the disk array apparatus 3, determines the write-data write destination LBA. Note that, for the LUN of the logical volume VOL which is the write-data write destination, the LUN designated in the write command is applied as is.

Furthermore, when the foregoing write preliminary processing is complete, the microprocessor 8 transmits a notification to that effect (hereinafter called a ‘write preliminary processing completion notification) to the host computer 2 via the host interface control unit 6 (SP2). Thus, the host computer 2 subsequently transmits the write data to the disk array apparatus 3 in 512 byte units on the basis of this write preliminary processing completion notification.

Subsequently, the microprocessor 8 awaits the transmission of write data from the host computer 2 (SP3) and when notification is received from the host interface control unit 6 that write data (512 byte data 20A) from the host computer 2 has already been received, determines whether or not the host computer 2 supports the guarantee code (whether or not the guarantee code 20B has been added to the data) (SP4). Note that various information relating to the host computer 2 such as whether the host computer 2 supports the guarantee code is registered beforehand in the disk array apparatus 3 by the user and stored as host information in the memory 9. Accordingly, the microprocessor 8 determines the determination of step SP4 based on the host information of the host computer 2 stored in the memory 9.

Upon obtaining an affirmative result in the determination of step SP4, the microprocessor 8 controls the host interface control unit 6 to check that there are no errors in the 512 byte data 20A on the basis of the guarantee code 20B added to the 512 byte data 20A (SP5) and when no errors are present, controls the host interface control unit 6 and data transfer control unit 13 to store the 512 byte data 20A and the guarantee code 20B in the cache memory 10 (SP7).

In contrast, upon obtaining a negative result in the determination of step SP4, the microprocessor 8 controls the host interface control unit 6 so as to generate the guarantee code 20B for the 512 byte data 20A each time the 512 byte data 20A is received, and adds the generated guarantee code 20B to the 512 byte data 20A (SP6). Furthermore, the microprocessor 8 subsequently controls the host interface control unit 6 and data transfer control unit 13 to store the 512 byte data 20A and the guarantee code 20B in the cache memory 10 (SP7).

The microprocessor 8 subsequently determines whether or not reception of all the write data (512 byte data 20A) is complete (SP8). The microprocessor 8 then returns to step SP3 upon obtaining a negative result in this determination and subsequently repeats the processing of steps SP3 to SP8.

Furthermore, upon obtaining an affirmative result in step SP8 as a result of reception of all the write data (512 byte data 20A) already being complete, the microprocessor 8 transmits a write completion report to the effect that write processing is complete to the host computer 2 via the host interface control unit 6 (SP9).

Thereafter, the microprocessor 8 determines whether or not the write destination, of the first 512 byte data 20A among the 512 byte data 20A which have not yet undergone the processing of steps SP10 to SP13, described subsequently, which is 512 byte data 20A stored in the cache memory 10, matches the boundaries of the logical blocks to which the 512 byte data 20A is to be written and whether or not there are eight or more 512 byte data 20A which have not yet undergone the processing of steps SP10 to SP13 (SP10).

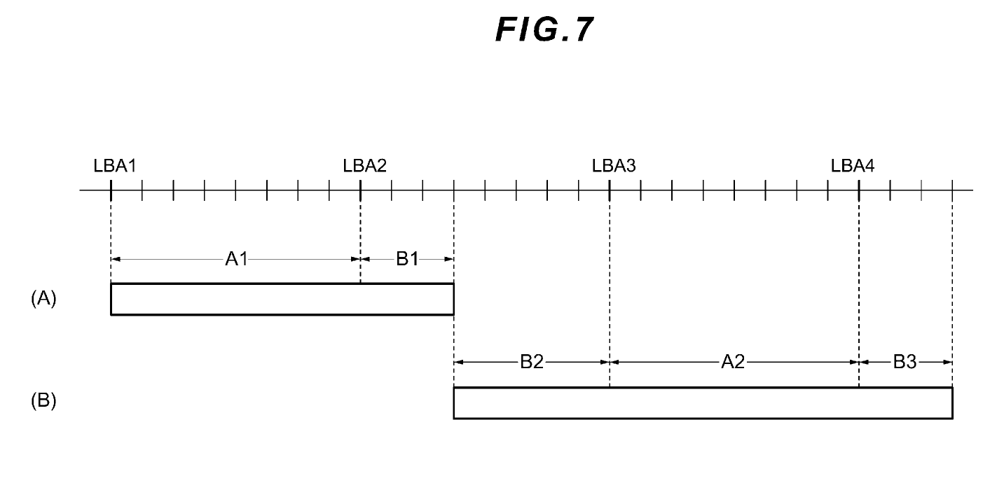

Obtaining an affirmative result in the determination of step SP10 means that, as shown in FIG. 7A, for example, the write destination of the first 512 byte data 20A matches the boundaries of the logical block (in the example of FIG. 7A, a logical block whose LBA is ‘LBA1’) to which the 512 byte data 20A is written), and that there are eight or more write-target 512 byte data 20A which have not yet undergone the processing of steps SP10 to SP13. Accordingly, here the microprocessor 8 supplies an instruction (hereinafter called ‘first block size conversion processing execution instruction’) to the data transfer control unit 13 to execute first block size conversion processing.

Accordingly, upon receiving the first block size conversion processing execution instruction, the data transfer control unit 13 generates 4 kilobyte data 21A by integrating eight, starting with the first, of the 512 byte data 20A which have not yet undergone the processing of steps SP10 to SP13 among the write-target 512 byte data 20A stored in the cache memory 10 and generates a new guarantee code 21B for the 4 kilobyte data 21A thus generated, adds this guarantee code 21B to the 4 kilobyte data 21A and then stores the 4 kilobyte data 21A to which the guarantee code 21B has been added in the cache memory 10.

However, obtaining a negative result in the determination of step SP10 means, as shown in FIG. 7B, for example, that the write destination of this first 512 byte data 20A does not match the boundaries of the logical block to which the 512 byte data 20A is to be written (in the example of FIG. 7B, a logical block whose LBA is ‘LBA2’) or there is a match but there are less than eight 512 byte data 20A which have not yet undergone the processing of steps SP10 to SP13. Accordingly, here the microprocessor 8 supplies an instruction (hereinafter called ‘second block size conversion processing execution instruction’) to the data transfer control unit 13 to execute second block size conversion processing.

Thus, upon receiving the second block size conversion processing execution instruction, the second the data transfer control unit 13 reads, to the cache memory 10, all the data (4 kilobyte data 21A) of the logical block to which the first 512 byte data 20A is to be written in the logical volume VOL to which the first 512 byte data 20A is to be written among the 512 byte data 20A which have not yet undergone the processing of steps SP10 to SP13, and executes read modify write processing which overwrites the corresponding position in the 4 kilobyte data 21A thus read with the 512 byte data 20A which is to be written to the logical block. Furthermore, the data transfer control unit 13 generates the guarantee code 21B of the 4 kilobyte data 21A updated in this way and adds the generated guarantee code 21B to the 4 kilobyte data 21A.

Subsequently, the microprocessor 8 determines whether or not the processing of steps SP10 to SP13 has been executed for all the write-target 512 byte data 20A stored in the cache memory 10 is complete (SP13). Further, upon obtaining a negative result in this determination, the microprocessor 8 returns to step SP10 and subsequently repeats the processing of steps SP10 to SP13.

As a result of the processing of steps SP10 to SP13 hereinabove, at the write destination, each of the 512 byte data 20A included in a range denoted ‘A1’ in FIG. 7A and each of the 512 byte data 20A included in a range denoted ‘A2’ in FIG. 7B, for example, are integrated with the 4 kilobyte data 21A by means of the foregoing first block size conversion processing and each of the 512 byte data 20A included in a range denoted ‘B1’ in FIG. 7A and each of the 512 byte data 20A included in ranges denoted ‘B2’ and ‘B3’ in FIG. 7B are integrated with the 4 kilobyte data 21A and the data written to the corresponding logical block by the foregoing second block size conversion processing.

Thereafter, the microprocessor 8 controls the data transfer control unit 13 so as to generate parity data respectively for each of the 4 kilobyte data 21A generated in step SP11 or SP12 (SP14). Accordingly, the data transfer control unit 13 sequentially reads each of the 4 kilobyte data 21A generated in step SP11 or SP12 from the cache memory 10, generates parity data for the 4 kilobyte data 21A, creates a guarantee code for the generated parity data and adds this guarantee code to the parity data, and subsequently stores the parity data and guarantee code in the cache memory 10.

Subsequently, the microprocessor 8 controls the data transfer control unit 13 so that same transmits the 4 kilobyte data 21A and guarantee code 21B generated by the processing of steps SP10 to SP14 together with the parity data and the guarantee code for this parity data to disk interface control unit 11 (SP15). These data are accordingly read from the cache memory 10 by the data transfer control unit 13 and transferred to the disk interface control unit 11.

In addition, the microprocessor 8 causes the disk interface control unit 11 to check that there are no errors in the 4 kilobyte data on the basis of the guarantee code 21B which is added to each of the 4 kilobyte data 21A and, when no errors exist, the microprocessor 8 controls the disk interface control unit 11 (SP16) so that same stores the 4 kilobyte data 21A and guarantee code 21B in the logical block which is assigned the LBA determined in step SP1 in the logical volume VOL which is assigned the LUN determined in step SP1 and then terminates the write processing.

### (1-4) Read Processing According to this Embodiment

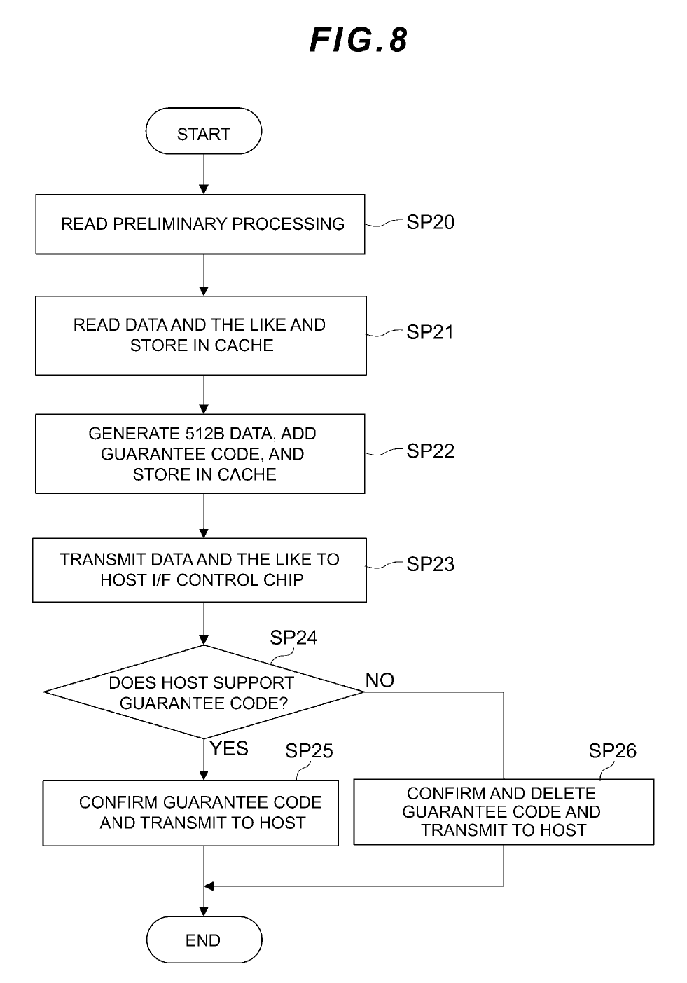

Meanwhile, FIG. 8 shows a processing routine for read processing which is executed by the microprocessor 8 of the disk array apparatus 3 which receives the read command from the host computer 2.

Upon receiving the read command issued by the host computer 2 via the host interface control unit 6, the microprocessor 8 starts the read processing and first executes predetermined preliminary processing for transferring the read data to the host computer 2 (hereinafter called ‘read preliminary processing’) (SP20).

More specifically, the microprocessor 8 reserves a storage area, for temporarily storing the read data read from the logical volume VOL, in the cache memory 10. In addition, the microprocessor 8 refers to the LBA conversion table 30 and determines the LBA of the data read destination by converting the LBA designated as the data read destination in the read command to the corresponding LBA in the disk array apparatus 3. Note that, for the LUN of the logical volume VOL of the data read destination, the LUN designated in the read command is applied as is.

Furthermore, upon completing the foregoing read preliminary processing, the microprocessor 8 controls the disk interface control unit 11 so that same reads data from the logical block which has been assigned the LBA determined in step SP20 in the logical volume VOL which has been assigned the LUN designated by the read command (SP21). Accordingly, the disk interface control unit 11 reads the 4 kilobyte data 21A and the guarantee code 21B and the like stored in this logical block in the logical volume VOL, determines whether or not there are any errors in the 4 kilobyte data 21A on the basis of the guarantee code 21B thus read and, when there are no errors, stores the 4 kilobyte data 21A and guarantee code 21B in the cache memory 10 via the data transfer control unit 13.

Subsequently, the microprocessor 8 supplies an instruction (hereinafter called ‘third block size conversion processing execution instruction’) to the data transfer control unit 13 so that same executes third block size conversion processing (SP22).

Accordingly, upon receiving the third block size conversion processing execution instruction, the data transfer control unit 13 converts each of the read-target 4 kilobyte data 21A stored in the cache memory 10 into eight 512 byte data 20A by sequentially dividing the 4 kilobyte data 21A, starting with the first, into 512 byte units, generates a new guarantee code 20B for each of the 512 byte data 20A, adds the generated guarantee codes 20B to each of the corresponding 512 byte data 20A, and stores the 512 byte data 20A, to which the guarantee codes 20B have been added, in the cache memory 10.

Subsequently, the microprocessor 8 controls the data transfer control unit 13 so that same transmits each of the 512 byte data 20A and guarantee codes 20B thereof generated by the processing of step SP23 to the host interface control unit 6 (SP23). Accordingly, the 512 byte data 20A and guarantee codes 20B are read from the cache memory 10 by the data transfer control unit 13 and transferred to the host interface control unit 6.

Thereafter, the microprocessor 8 determines whether or not the corresponding host computer 2 supports the guarantee code on the basis of the foregoing host information stored in the memory 9 (SP24).

Furthermore, upon obtaining an affirmative result in this determination, the microprocessor 8 supplies the first block size conversion processing execution instruction which corresponds to this result to the host interface control unit 6. The host interface control unit 6 thus checks that there are no errors in the 512 byte data 20A on the basis of the guarantee code 20B added to the 512 byte data 20A for each of the 512 byte data 20A on the basis of the first data transfer instruction and, if there are no errors, transmits the 512 byte data 20A and guarantee codes 20B to the host computer 2 (SP25).

However, upon obtaining a negative result in the determination of step SP24, the microprocessor 8 supplies the second data transmission instruction which corresponds to this result to the host interface control unit 6. The host interface control unit 6 thus checks that there are no errors in the 512 byte data 20A on the basis of the guarantee code 20B added to the 512 byte data 20A for each of the 512 byte data 20A on the basis of the second data transfer instruction and, if there are no errors, transmits the 512 byte data 20A to the host computer 2 after deleting the guarantee codes 20B from the 512 byte data 20A (SP26).

The microprocessor 8 subsequently terminates this read processing.

### (1-5) Effect of this Embodiment

As described hereinabove, with the computer system 1 according to this embodiment, during write processing, the disk array apparatus 3 converts the write data transmitted from the host computer 2 into the same data size as the block size of the logical volume VOL provided by the disk array apparatus 3 and then writes the converted data to the relevant logical volume VOL and, during read processing, the disk array apparatus 3 converts the read data read from the logical volume VOL into the block size of the host computer 2 and then transfers the converted data to the host computer 2, thus enabling data processing such as write processing and read processing to be suitably executed by the disk array apparatus even if there is a difference in block size between the host computer 2 and the disk array apparatus 3. The guarantee codes 20B and 21B can also be supported, thereby enabling implementation of a reliable device.

### (2) Second Embodiment

### (2-1) Configuration of Computer System

In FIG. 1, 40 indicates the whole computer system according to a second embodiment. This computer system 40 differs from the computer system 1 according to the first embodiment in that the block size of data in a host computer 41 is 4 kilobytes and the block size of data in a disk array apparatus 42 is 512 bytes.

Hence, in the case of this embodiment, during a write operation, the host computer 41 transmits write data in 4 kilobyte units together with a write command to the disk array apparatus 42. Here, if a guarantee code is supported, the host computer 41 adds an 8 byte guarantee code 21B to the write data (4 kilobyte data 21A) for every 4 kilobytes of write data (see FIG. 2B).

In addition, upon receiving a write command and one or more write-target 4 kilobyte data 21A from the host computer 41, the disk array apparatus 42 sequentially stores the 4 kilobyte data 21A in the cache memory 10. Here, if the host computer 41 does not support guarantee codes, the guarantee code 21B is added to each of the 4 kilobyte data 21A.

Furthermore, the disk array apparatus 42 subsequently divides each of the write-target 4 kilobyte data 21A stored in the cache memory 10 into 512 byte units and, after adding an 8 byte guarantee code 20B to each of the 512 byte data 20A thus obtained (see FIG. 2A), writes the data to the corresponding logical block in the logical volume VOL designated in the write command.

Meanwhile, if a read command is supplied from the host computer 41, the disk array apparatus 42 reads the 512 byte data 20A and guarantee code 20B from the corresponding plurality of logical blocks in the logical volume VOL designated in the read command and stores the 512 byte data 20A and guarantee code 20B thus read in the cache memory 10.

In addition, the disk array apparatus 42 integrates, in lots of eight, the 512 byte data 20A stored in the cache memory 10 to generate the 4 kilobyte data 21A, and transmits the generated 4 kilobyte data 21A to the host computer 41. Here, if the host computer 41 supports the guarantee code, the disk array apparatus 3 transmits the 4 kilobyte data 21A after adding a new guarantee code 21B which is calculated on the basis of the 4 kilobyte data 21A.

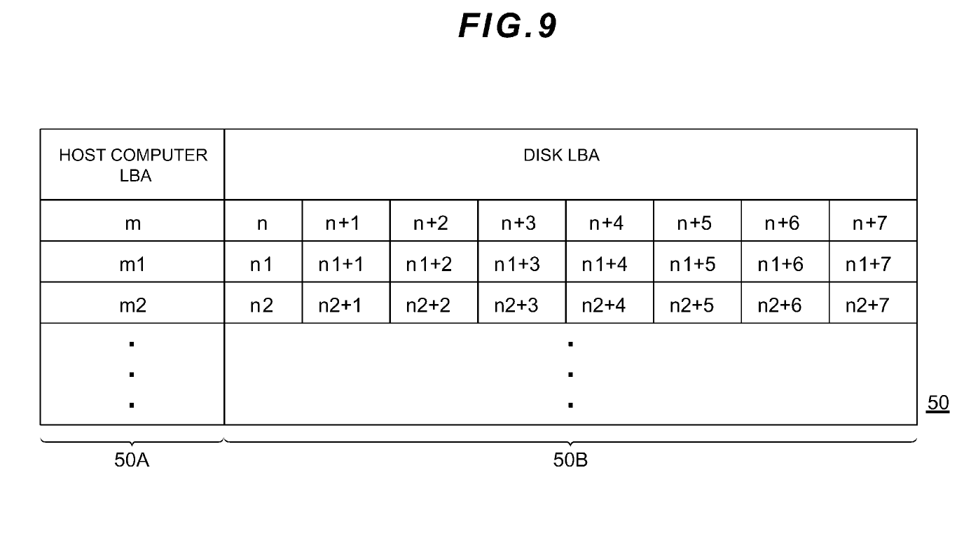

As means for executing block size conversion processing according to this embodiment as described earlier, the memory 9 of a disk array controller 43 of the disk array apparatus 42 stores, in place of the foregoing LBA conversion table 30 in FIG. 5, an LBA conversion table 50 as shown in FIG. 9 for each logical volume VOL.

Similarly to the LBA conversion table 30 according to the first embodiment, the LBA conversion table 50 is a table which is used to manage the correspondence relationships between the LBA recognized by the host computer 41 of each of the logical volumes VOL and the LBA managed by the disk array apparatus 42 and, as shown in FIG. 9, is configured from a disk LBA field 50A and a host computer LBA field 50B.

Furthermore, the disk LBA field 50A stores the disk LBA which are assigned to each storage area (logical block) for every 512 bytes of the corresponding logical volume VOL and the host computer LBA field 50B stores the host LBA recognized by the host computer 2 for eight storage areas to which the corresponding disk LBA are assigned.

Hence, FIG. 9 shows, for example, that the host LBA ‘m’ corresponds to the disk LBA ‘n’ to ‘n+7’, the host LBA ‘m1’ corresponds to the disk LBA ‘n1’ to ‘n1+7’, and the host LBA ‘m2’ corresponds to the disk LBA ‘n2’ to ‘n2+7’.

Accordingly, if a write command in which the write destination is the LBA ‘m’ in the corresponding logical volume VOL is supplied to the disk array apparatus 42 from the host computer 41, this data is written to eight logical blocks which have been assigned the LBA ‘n’ to ‘n+7’ respectively in the logical volume VOL. Furthermore, if a read command in which the read destination is the LBA ‘m1’ in the corresponding logical volume VOL is supplied to the disk array apparatus 42 by the host computer 41, this data is read from the eight logical blocks which have been assigned the LBA ‘n1’ to ‘n1+7’ in the logical volume VOL.

### (2-2) Write Processing According to this Embodiment

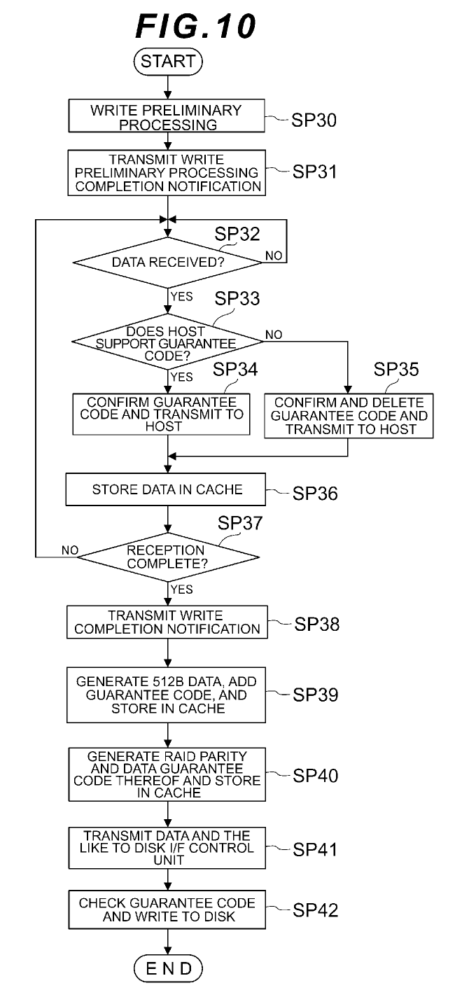

FIG. 10 shows a processing routine for write processing according to this embodiment which is executed by a microprocessor 45 of a disk array apparatus 42 which receives the write command from a host computer 41.

Upon receiving the write command issued by the host computer 41 via the host interface control unit 6, the microprocessor 45 starts the write processing and processes steps SP30 to SP38 in the same way as the write processing steps SP1 to SP9 according to the foregoing first embodiment in FIG. 6. Accordingly, the 4 kilobyte data 21A of the write target from the host computer 41 is stored in the cache memory 10 of the disk array apparatus 42 and the write completion notification is transmitted to the host computer 41.

Subsequently, the microprocessor 45 supplies an instruction to a data transfer control unit 46 to execute fourth block size conversion processing (hereinafter called ‘fourth block size conversion processing execution instruction’) (SP39).

Accordingly, upon receiving the fourth block size conversion processing execution instruction, the data transfer control unit 46 generates eight 512 byte data 20A for a single 4 kilobyte data 21A by sequentially dividing the write-target 4 kilobyte data 21A stored in the cache memory 10 in 512 byte units starting with the first 4 kilobyte data 21A. Furthermore, the data transfer control unit 46 generates new guarantee codes 20B for the 512 byte data 20A respectively, adds the generated guarantee codes 20B to the corresponding 512 byte data 20A, and stores the 512 byte data 20A to which the guarantee codes 20B have been added in the cache memory 10.

In addition, the microprocessor 45 subsequently processes steps SP40 to SP42 in the same way as the write processing steps SP14 to SP16 according to the first embodiment described earlier with reference to FIG. 6 and then terminates the write processing.

### (2-3) Read Processing According to this Embodiment

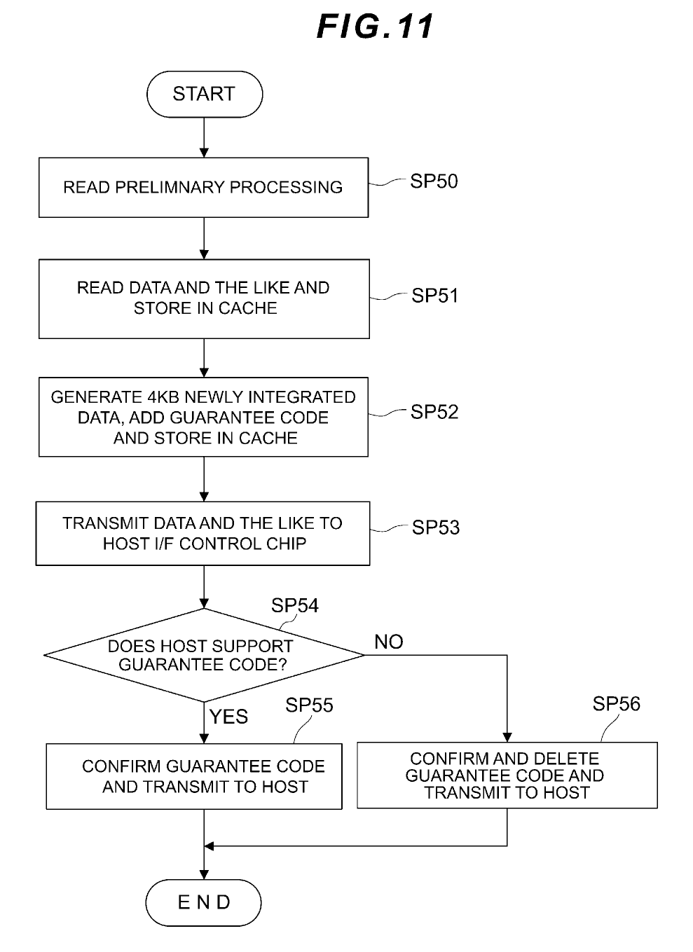

Meanwhile, FIG. 11 shows a processing routine for read processing according to this embodiment which is executed by the microprocessor 45 of the disk array apparatus 42 which receives the read command from the host computer 41.

Upon receiving the read command issued by the host computer 41 via the host interface control unit 6, the microprocessor 45 starts the read processing and processes steps SP50 to SP51 in the same way as the write processing steps SP20 to SP21 according to the first embodiment described earlier with reference to FIG. 6. Accordingly, the 512 byte data 20A and guarantee codes 20B and so on are read from the logical blocks corresponding to the LBA designated in the read command in the logical volume VOL which have been assigned the LUN designated in the read command, and the 512 byte data 20A and guarantee codes 20B are stored in the cache memory 10 via the data transfer control unit 46.

Thereafter, the microprocessor 45 supplies an instruction (hereinafter called ‘fifth block size conversion processing execution instruction’) to the data transfer control unit 46 so that same executes fifth block size conversion processing (SP52).

Accordingly, upon receiving the fifth block size conversion processing execution instruction, the data transfer control unit 46 generates 4 kilobyte data 21A by sequentially integrating, starting with the first, eight of the read-target 512 byte data 20A stored in the cache memory 10, generates a new guarantee code 21B for the generated 4 kilobyte data 21A, adds the guarantee code 21B to the 4 kilobyte data 21A, and stores the 4 kilobyte data 21A to which the guarantee code 21B is added in the cache memory 10.

Furthermore, the microprocessor 45 subsequently processes steps SP53 to SP56 in the same way as the read processing steps SP23 to SP26 according to the first embodiment described earlier with reference to FIG. 6, and then terminates the read processing.

### (2-4) Effect of the Embodiment

As described hereinabove, similarly to the computer system 1 according to the first embodiment, in the computer system 40 according to this embodiment, during write processing, the disk array apparatus 43 converts the write data transmitted from the host computer 41 into the same data size as the block size of the logical volume VOL provided by the disk array apparatus 43 and then writes the converted data to the relevant logical volume VOL and, during read processing, the disk array apparatus 43 converts the read data read from the logical volume VOL into the block size of the host computer 41 and then transfers the converted data to the host computer 41, thus enabling the prevention of an increase in usage bandwidth during a data transfer between the host computer 41 and disk array apparatus 43 and allowing a disk array apparatus to be implemented with which the communication bandwidth between the host computer 41 and disk array apparatus 43 can be efficiently used.

### (3) Third Embodiment

### (3-1) Configuration of Computer System

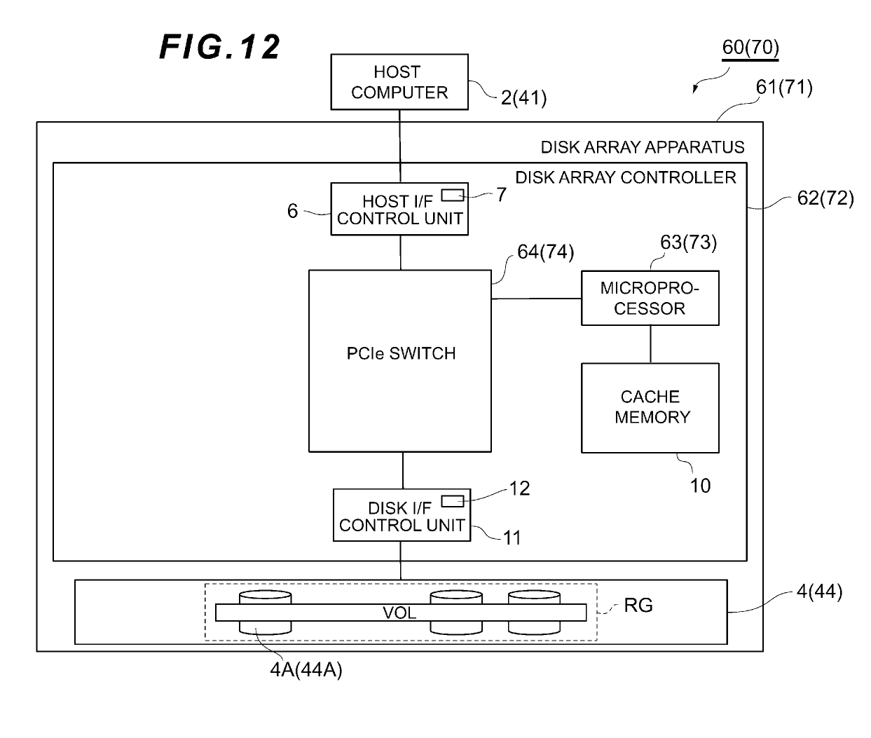

In FIG. 12, which shows parts corresponding to those in FIG. 1 with the same reference numerals assigned thereto, 60 indicates the whole computer system according to a third embodiment. This computer system 60 differs from the computer system 1 according to the first embodiment in that a general-purpose PCIe (PCI Express) switch 64 is applied in place of the data transfer control unit 13 (FIG. 1) and in that the processing content of the read processing and write processing which is executed by a microprocessor 63 is accordingly different.

In reality, with this embodiment, the PCIe switch 64 of a disk array apparatus 61 is connected to the host interface control unit 6, the disk interface control unit 11, and the microprocessor 63. The transmission and reception of data between the host interface control unit 6, the disk interface control unit 11, and the microprocessor 63 are executed via the PCIe switch 64.

Furthermore, according to this embodiment, the cache memory 10 is connected to the microprocessor 63 and, in addition to being used to temporarily store write data which is transmitted from the host computer 2 and read data which is read from the logical volume VOL, is also used as a memory for storing various control programs and various control information (including the foregoing LBA conversion table 50 described earlier with reference to FIG. 9).

In addition, if the write command and one or more write-target read data (512 byte data 20A) from the host computer 2 are received, the disk array apparatus 61 sequentially stores the 512 byte data 20A in the cache memory 10. Here, if the host computer 2 does not support guarantee codes, the guarantee code 20B is added to each of the 512 byte data 20A.

Furthermore, the disk array apparatus 61 subsequently integrates, eight at a time and in sequence, the 512 byte data 20A stored in the cache memory 10 to generate 4 kilobyte data 21A, adds an 8 byte guarantee code 21B to the generated 4 kilobyte data 21A (see FIG. 2B) and subsequently writes the 4 kilobyte data 21A and guarantee code 21B to the corresponding logical block in the logical volume VOL designated in the write command.

Meanwhile, if a read command is supplied from the host computer 2, the disk array apparatus 61 reads the 4 kilobyte data 21A and guarantee code 21B from the corresponding logical blocks in the logical volume VOL designated in the read command and stores the 4 kilobyte data 21A and guarantee code 21B thus read in the cache memory 10.

Furthermore, the disk array apparatus 61 subsequently divides each of the 4 kilobyte data 21A stored in the cache memory 10 into 512 byte units, starting with the first, thereby generating eight 512 byte data 20A for one 4 kilobyte data 21A, and transmits each of the 512 byte data 20A thus generated to the host computer 2. Here, if the host computer 2 supports guarantee codes, the disk array apparatus 61 transmits the 4 kilobyte data after adding a new guarantee code 20A which is calculated on the basis of the 512 byte data 20A.

### (3-2) Write Processing According to this Embodiment

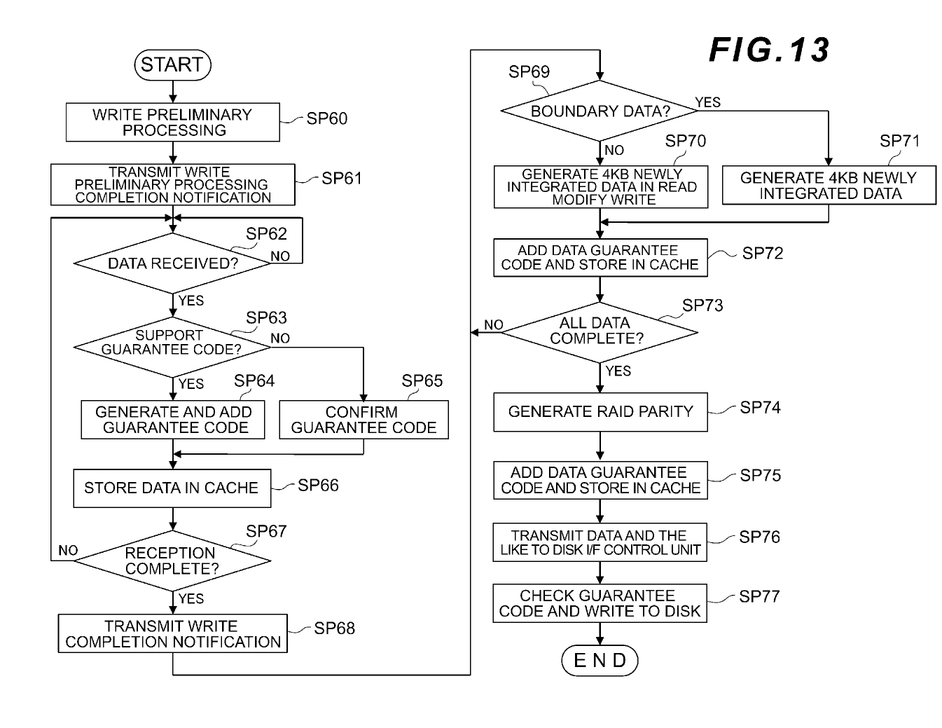

FIG. 13 shows a processing routine for write processing according to this embodiment which is executed by the microprocessor 63 of the disk array apparatus 61 which receives a write command from the host computer 2.

Upon receiving a write command which is issued by the host computer 2 via the host interface control unit 6, the microprocessor 63 starts the write processing and performs steps SP60 to SP65 in the same way as the write processing steps SP1 to SP5 according to the first embodiment described earlier with reference to FIG. 6.

Thereafter, the microprocessor 63 stores the 512 byte data 20A and the guarantee code 20B which are acquired in the foregoing steps SP64 and SP65 in the cache memory 10 (SP66) and subsequently performs steps SP67 and SP68 in the same way as the write processing steps SP8 and SP9 according to the first embodiment described earlier with reference to FIG. 6.

Subsequently, the microprocessor 63 determines whether or not the write destination, of the first 512 byte data 20A among the 512 byte data 20A which have not yet undergone the processing of steps SP69 to SP72, described subsequently, matches the boundaries of the logical blocks to which the 512 byte data 20A is to be written and whether or not there are eight or more write-target 512 byte data 20A which have not yet undergone the processing of steps SP69 to SP72 (SP69).

Furthermore, upon obtaining an affirmative result in this determination, the microprocessor 63 generates 4 kilobyte data 21A by integrating eight, starting with the first, of the 512 byte data 20A which have not yet undergone the processing of steps SP69 to SP73, described subsequently, among the write-target 512 byte data 20A stored in the cache memory 10 and then stores the 4 kilobyte data 21A in the cache memory 10 (SP70).

However, upon obtaining an affirmative result in the determination of step SP69, the microprocessor 63 reads, to the cache memory 10, all the data (4 kilobyte data 21A) of the logical block to which the first 512 byte data 20A is to be written in the logical volume VOL to which the first 512 byte data 20A is to be written among the 512 byte data 20A which have not yet undergone the processing of steps SP69 to SP73 and generates 4 kilobyte data 21A by executing read modify write processing which overwrites the corresponding position in the 4 kilobyte data 21A thus read with the 512 byte data 20A which is to be written to the logical block, storing the 4 kilobyte data 21A in the cache memory 10 (SP71).

Thereafter, the microprocessor 63 generates a guarantee code 21B for the 4 kilobyte data 21A created in steps SP70 and SP71, adds the generated guarantee code 21B to the 4 kilobyte data 21A, and stores the 4 kilobyte data 21A to which the guarantee code 21B has been added in the cache memory 10 (SP72).

Subsequently, the microprocessor 63 determines whether or not the processing of steps SP69 to SP73 has been executed for all the write-target 512 byte data 20A stored in the cache memory 10 has been executed (SP73). Further, upon obtaining a negative result in this determination, the microprocessor 63 returns to step SP69 and subsequently repeats the processing of steps SP69 to SP73.

The microprocessor 63 then generates parity data for the 4 kilobyte data 21A generated in step SP70 or SP71 and stores the generated parity data in the cache memory 10 (SP74).

Furthermore, the microprocessor 63 reads the parity data generated in step SP74 from the cache memory 10, creates a guarantee code for the parity data and adds this guarantee code to the parity data, and then stores the parity data and the guarantee code in the cache memory 10 (SP75).

Subsequently, the microprocessor 63 transmits each of the 4 kilobyte data 21A and guarantee codes 21B as well as the parity data and guarantee code of the parity data to the disk interface control unit 11 (SP76).

Furthermore, the microprocessor 8 causes the disk interface control unit 12 to check that there are no errors in the 4 kilobyte data 21A on the basis of the guarantee codes 21B added to the 4 kilobyte data 21A respectively and, if there are no errors, controls the disk interface control unit 11 so that same stores the 4 kilobyte data 21A and guarantee codes 21B as well as the parity data and guarantee code of the parity data in the corresponding logical blocks in the corresponding logical volume VOL (SP16) and subsequently terminates the write processing.

### (3-3) Read Processing According to this Embodiment

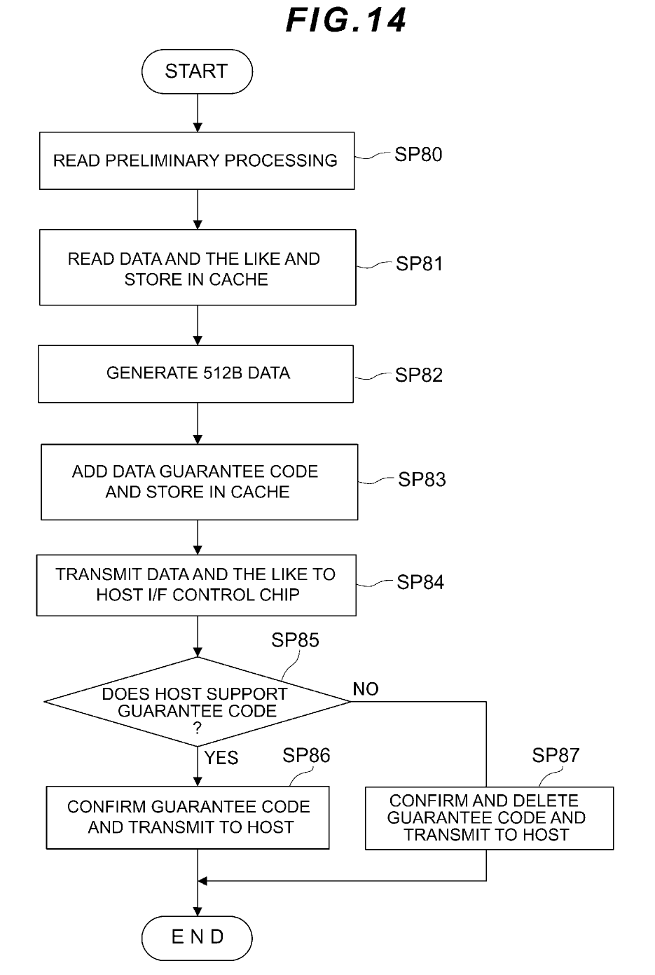

Meanwhile, FIG. 14 shows a processing routine for write processing which is executed by the microprocessor 63 of the disk array apparatus 61 which receives the write command from the host computer 2.

Upon receiving the read command issued by the host computer 2 via the host interface control unit 6, the microprocessor 63 starts the read processing and executes steps SP80 and SP81 in the same way as the write processing steps SP20 and SP21 according to the first embodiment described earlier with reference to FIG. 6. As a result, the data designated in the read command (here, the 4 kilobyte data 21A) and the guarantee codes 21B and the like are read from the corresponding logical volume VOL, and the 4 kilobyte data 21A and guarantee codes 21B and the like are stored in the cache memory 10 via the PCIe switch 64.

The microprocessor 63 then generates a plurality of 512 byte data 20A by sequentially dividing, in 512 byte units starting with the first, the 4 kilobyte data 21A stored in the cache memory 10 and stores the 512 byte data 20A in the cache memory 10 (SP82).

Furthermore, the microprocessor 63 sequentially reads the 512 byte data 20A created in step SP82 from the cache memory 10, generates guarantee codes 20B for the 512 byte data 20A, adds the generated guarantee codes 20B to the 512 byte data 20A, and stores the 512 byte data 20A to which the guarantee codes 20B have been added in the cache memory 10 (SP83).

Thereafter, the microprocessor 63 transmits each of the 512 byte data 20A and guarantee codes 20B generated by the processing of step SP83 to the host interface control unit 6 (SP84). The 512 byte data 20A and the guarantee codes 20B thereof are thus read from the cache memory 10 by the microprocessor 63 and transferred to the host interface control unit 6 via the PCIe switch 64.

In addition, the microprocessor 63 subsequently transmits the foregoing 512 byte data 20A to the host computer 2 in sequence by performing steps SP85 to SP87 in the same way as the read processing steps SP24 to SP26 according to the first embodiment described earlier with reference to FIG. 6, and then terminates the read processing.

### (3-4) Effect of this Embodiment

As described hereinabove, in the computer system 60 according to this embodiment, a general-purpose PCIe switch 64 is applied in place of the data transfer control unit 13 (FIG. 1) according to the first embodiment, and the microprocessor 63 is configured to perform block size conversion processing to convert the block size of the write data and read data during read processing and write processing and hence, in addition to the effect obtained by the first embodiment, this embodiment is also able to provide the effect of enabling the disk array apparatus 61 to be constructed at low cost.

### (4) Fourth Embodiment

### (4-1) Configuration of Computer System

In FIG. 12, 70 indicates the whole computer system according to a fourth embodiment. This computer system 70 differs from the computer system 60 according to the third embodiment in that the block size of the data in the host computer 41 is 4 kilobytes and the block size of data in a disk array apparatus 71 is 512 bytes.

Hence, in the case of this embodiment, during a write operation, the host computer 41 transmits write data 4 kilobytes at a time together with a write command to the disk array apparatus 71. Here, if a guarantee code is supported, the host computer 41 adds an 8 byte guarantee code 21B to the write data (4 kilobyte data 21A) for every 4 kilobytes of write data (see FIG. 2B).

In addition, upon receiving a write command and one or more write-target 4 kilobyte data 21A from the host computer 41, the disk array apparatus 71 sequentially stores the 4 kilobyte data 21A in the cache memory 10. Here, if the host computer 2 does not support guarantee codes, the guarantee code 21B is added to each of the 4 kilobyte data 21A.

Furthermore, the disk array apparatus 71 subsequently divides each of the 4 kilobyte data 21A stored in the cache memory 10 into 512 byte units and, after adding an 8 byte guarantee code 20B to the plurality of 512 byte data 20A thus obtained (see FIG. 2A), writes these 512 byte data 20A and guarantee codes 20B to the corresponding logical block in the logical volume VOL designated in the write command.

Meanwhile, if a read command is supplied from the host computer 41, the disk array apparatus 71 reads the 512 byte data 20A and guarantee code 20B from the corresponding plurality of logical blocks in the logical volume VOL designated in the read command and stores the 512 byte data 20A and guarantee code 20B thus read in the cache memory 10.

In addition, the disk array apparatus 71 integrates, in lots of eight, the 512 byte data 20A stored in the cache memory 10 to generate the 4 kilobyte data 21A, and transmits the generated 4 kilobyte data 21A to the host computer 41. Here, if the host computer 41 supports the guarantee code, the disk array apparatus 71 transmits the 4 kilobyte data 21A after adding a new guarantee code 21B which is calculated on the basis of the 4 kilobyte data 21A.

As means for executing block size conversion processing according to this embodiment as described earlier, the memory 9 of a disk array controller 72 of the disk array apparatus 71 stores, in place of the foregoing LBA conversion table 30 in FIG. 5, an LBA conversion table 50 described earlier with reference to FIG. 9 for each logical volume VOL. Thus, the disk array apparatus 71 executes read processing and write processing as described earlier by using the LBA conversion table 50.

### (4-2) Write Processing According to this Embodiment

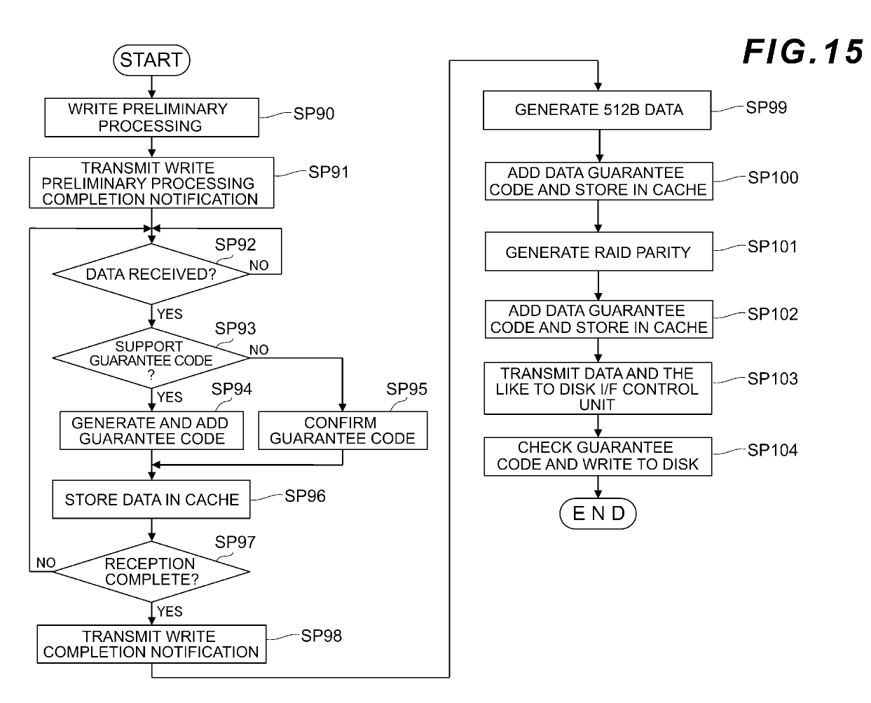

FIG. 15 shows a processing routine for write processing according to this embodiment which is executed by a microprocessor 73 of the disk array apparatus 71 which receives the write command from the host computer 41.

Upon receiving a write command which is issued by the host computer 41 via the host interface control unit 6, the microprocessor 73 starts write processing and processes steps SP90 to SP98 in the same way as the write processing steps SP60 to SP68 according to the foregoing third embodiment described earlier with reference to FIG. 13. As a result, the write target 4 kilobyte data 21A from the host computer 41 is stored in the cache memory 10 of the disk array apparatus 71 and a write completion notification is transmitted to the host computer 41.

Thereafter, the microprocessor 73 generates eight 512 byte data 20A for a single 4 kilobyte data 21A by sequentially dividing the write-target 4 kilobyte data 21A stored in the cache memory 10 in 512 byte units starting with the first 4 kilobyte data 21A, and stores the generated 512 byte data 20A in the cache memory 10 (SP99).

In addition, the microprocessor 73 subsequently processes steps SP100 to SP104 in the same way as the write processing steps SP72 to SP77 according to the third embodiment described earlier with reference to FIG. 13 and then terminates the write processing.

### (4-3) Read Processing According to this Embodiment

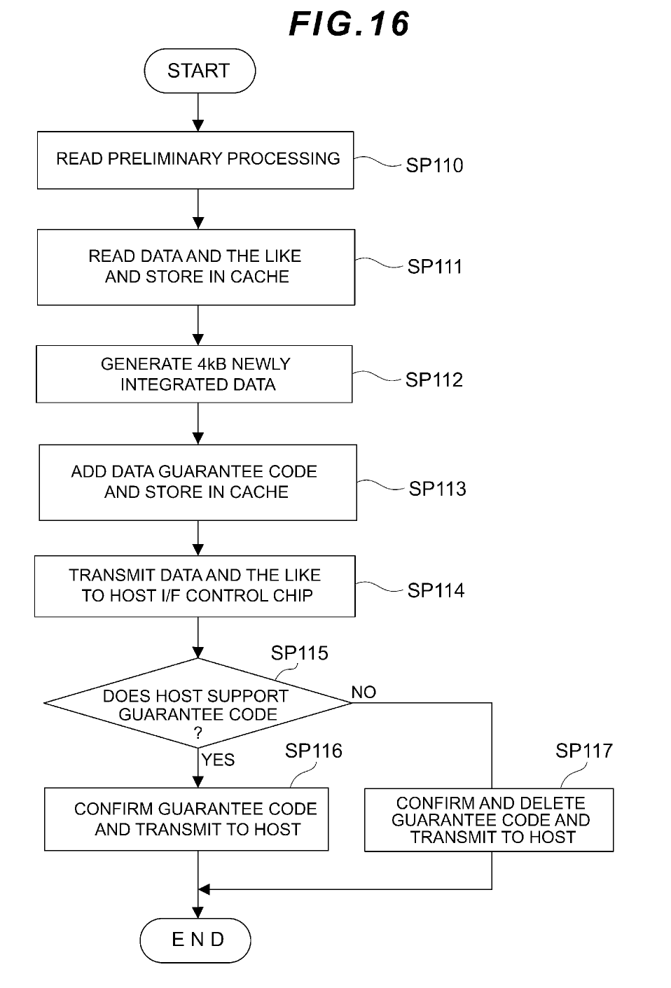

Meanwhile, FIG. 16 shows a processing routine for read processing according to this embodiment which is executed by the microprocessor 73 of the disk array apparatus 71 which receives the read command from the host computer 41.

Upon receiving the read command issued by the host computer 41 via the host interface control unit 6, the microprocessor 73 starts the read processing and processes steps SP50 to SP51 in the same way as the write processing steps SP110 to SP111 in the same way as write processing steps SP80 to SP81 according to the third embodiment described earlier with reference to FIG. 14. Accordingly, the 512 byte data 20A and guarantee codes 20B and so on are read from the logical blocks corresponding to the LBA designated in the read command in the logical volume VOL which have been assigned the LUN designated in the read command, and the 512 byte data 20A and guarantee codes 20B are stored in the cache memory 10 via the PCIe switch 64.

Thereafter, the microprocessor 63 generates 4 kilobyte data 21A by sequentially integrating, starting with the first, eight of the 512 byte data 20A stored in the cache memory 10, and stores the 4 kilobyte data 21A in the cache memory 10 (SP112).

Furthermore, the microprocessor 63 subsequently processes steps SP113 to SP117 in the same way as the read processing steps SP83 to SP87 according to the third embodiment described earlier with reference to FIG. 14, and then terminates the read processing.

### (4-4) Effect of the Embodiment

As described hereinabove, similarly to the computer system 60 according to the third embodiment, in the computer system 70 according to this embodiment, a general-purpose PCIe switch 74 is applied in place of the dedicated data transfer control unit 13 (FIG. 1), and the microprocessor 73 is configured to perform block size conversion processing to convert the block size of the write data and read data during read processing and write processing and hence, in addition to the effect obtained by the second embodiment, this embodiment is also able to provide the effect of enabling the disk array apparatus 71 to be constructed at low cost.

### (5) Further Embodiments

Note that although a case was described in the foregoing first to fourth embodiments in which the 512 byte data 20A is converted to 4 kilobyte data 21A and the 4 kilobyte data 21A is converted to 512 byte data 20A, the present invention is not limited to this arrangement, other sizes also being applicable as the block sizes.

Furthermore, although a case was described in the foregoing third and fourth embodiments in which data transfers are performed by using the PCIe switch 64 in the disk array apparatuses 61, 71, the present invention is not limited to this arrangement, and a general-purpose chip set may also be used.

Further, in the foregoing first to fourth embodiments, a guarantee code check is performed when reading and writing data in the disk interface control unit 11 but the present invention is not limited to this arrangement, and data may also be read and written from the storage devices 4, 44 without performing the guarantee code check.

In addition, although a case was described in the foregoing first to fourth embodiments in which the data storage destination of the storage device units 4, 44 recognized by the host computers 2, 41 and the actual data storage destination in the storage device units 4, 44 are converted by using the LBA conversion table, the present invention is not limited to this arrangement, rather the information indicating the correspondence relationships between the data storage destination of the disk units recognized by the host computers 2, 41 and the actual data storage destination in the storage device units 4, 44 may be managed in a form other than a table.

In addition, the following processing may be executed in the foregoing first to fourth embodiments. If the disk array apparatus receives a write command to write data of a 4 KB block size from the host computer 2, the microprocessor confirms the block size of the storage devices which the write-destination logical unit comprises. Furthermore, (A) if the block size of the storage devices is 4 KB, the microprocessor temporarily stores the write data in the cache memory without converting this data and stores the write data in the storage devices, (B) if the storage-device block size is 512 B, the microprocessor may execute the foregoing write processing to convert the write-data block size from 4 KM to 512 B. That is, the microprocessor compares the write-data block sizes with the block size of the storage devices which the write destination LU comprises and, if both block sizes match, may execute the write processing of (A), and if both block sizes do not match, may execute the write processing of (B).

In addition, the microprocessor may execute the following processing in the foregoing first to fourth embodiments. If the disk array apparatus receives a write command to write data of a 512 B block size from the host computer 2, the microprocessor confirms the block size of the storage devices which the write-destination logical unit comprises. Further, (C) if the block size of the storage device is 512 B, the microprocessor temporarily stores the write data in the cache memory without converting this data and stores the write data in the storage devices, (D) if the storagedevice block size is 4 KB, the microprocessor may execute the foregoing write processing which converts the write-data block size from 4 KB to 512 B. That is, the microprocessor compares the write-data block size with the block size of the storage devices which the write-destination LU comprises and, if both block sizes match, may execute the write processing of (C), and if both block sizes do not match, may execute the write processing of (D).

In addition, the microprocessor may execute the following processing in the foregoing first to fourth embodiments. If the disk array apparatus receives a read command to read data as 4 KB-block size data from the host computer 2, the microprocessor confirms the block size of the storage devices which the read-destination logical unit comprises. Further, (E) if the block size of the storage device is 4 KB, the microprocessor temporarily stores the read data in the cache memory without converting this data and transfers the read data to the host computer, (F) if the storage-device block size is 512 B, the microprocessor may execute the foregoing read processing which converts the read-data block size from 512 B to 4 KB. That is, the microprocessor compares the block size of data which the host computer requests to read with the block size of the storage devices which the read-destination LU comprises and, if both block sizes match, may execute the read processing of (E), and if both block sizes do not match, may execute the read processing of (F).

In addition, the microprocessor may execute the following processing in the foregoing first to fourth embodiments. If the disk array apparatus receives a read command to read data as 512 B-block size data from the host computer 2, the microprocessor confirms the block size of the storage devices which the read-destination logical unit comprises. Further, (G) if the block size of the storage device is 512 B, the microprocessor temporarily stores the read data in the cache memory without converting this data and transfers the read data to the host computer, (H) if the storage-device block size is 4 KB, the microprocessor may execute the foregoing read processing which converts the read-data block size from 4 KB to 512 B. That is, the microprocessor compares the block size of data which the host computer requests to read with the block size of the storage devices which the read-destination LU comprises and, if both block sizes match, may execute the read processing of (G), and if both block sizes do not match, may execute the read processing of (H).

### INDUSTRIAL APPLICABILITY

The present invention can be widely applied to disk array apparatuses from and to which data is read and written by host computers of different data handling sizes.

### REFERENCE SIGNS LIST

1, 40, 60, 70 Computer system
2, 41 Host computer
3, 42, 61, 71 Disk array apparatus
4, 44 Storage device unit
4A, 44A Storage device
5, 43, 62, 72 Disk array controller
6 Host interface control unit
7, 12, 14 Guarantee code control unit
8, 45, 63, 73 Microprocessor
10 Cache memory
11 Disk interface control unit
13, 46 Data transfer control unit
30, 50 LBA conversion table
64, 74 PCIe switch

1. A disk array apparatus, comprising:
a plurality of first storage devices which store data; and
a controller which controls data I/Os to/from the plurality of first storage devices,
wherein, if a first write command is received from a host computer, the controller divides first write data related to the first write command into a plurality of second write data and adds a first guarantee code to each of the plurality of second write data and writes this data to the plurality of first storage devices, and
wherein, if a first read command is received from the host computer, the controller reads a plurality of first read data related to the first read command from the plurality of first storage devices, generates second read data obtained by combining the plurality of first read data, and adds a second guarantee code to the second read data and transmits the data to the host computer.

2. The disk array apparatus according to claim 1,
wherein the block size of the first write data and the block size of the second read data are block sizes for handling data in the host computer and the block size of the second write data and the block size of the first read data are block sizes of the plurality of first storage devices.

3. The disk array apparatus according to claim 2,
wherein the first guarantee codes added to the plurality of second write data each comprise data which is generated by an EXCLUSIVE-OR operation of the data contained in each of the second write data, and
wherein the second guarantee code added to the second read data contains data which is generated by an EXCLUSIVE-OR operation of the data contained in the second read data.

4. The disk array apparatus according to claim 3,
wherein, if the first write command is received from the host computer, the controller deletes the guarantee codes added to the first write data and divides the data into a plurality of second write data, and
wherein, if the first read command is received from the host computer, the controller deletes the guarantee code added to each of the plurality of first read data and generates the second read data.

5. The disk array apparatus according to claim 4,
wherein the controller
provides a logical volume formed by storage area of the plurality of first storage devices to the host computer,
holds correspondence relationship information indicating the correspondence relationship between a first logical block number in the logical volume identified by the host computer and a second logical block number in the logical volume managed by the controller,
if the first write command designating the first logical block number is received from the host computer, refers to the correspondence relationship information to determine the second logical block number which is the write destination in the logical volume and,
if the first read command designating the first logical block number is received from the host computer, refers to the correspondence relationship information to determine the second logical block number which is the read destination in the logical volume.

6. The disk array apparatus according to claim 5,
wherein, if the first write command is received from the host computer, the controller compares the block size for handling data in the host computer with the block size of the plurality of first storage devices and, if there is a difference between the block sizes, the controller divides the first write data related to the first write command into a plurality of second write data, adds a first guarantee code to each of the plurality of second write data and writes the data to the plurality of first storage devices, or
wherein, if a first read command is received from the host computer, the controller compares the block size for handling data in the host computer with the block size of the plurality of first storage devices and, if there is a difference between the block sizes, reads a plurality of first read data related to the first read command from the plurality of first storage devices, generates second read data by combining the plurality of first read data, and adds a second guarantee code to the second read data and transmits the data to the host computer.

7. The disk array apparatus according to claim 6,
wherein the controller comprises:
a first interface control unit which functions as an interface during communications with the host computer;
a second interface control unit which functions as an interface during communications with the storage device unit;
a cache memory which temporarily stores data which is read from/written to the logical volume; and
a data transfer control unit which controls data transfers between the first interface control unit, and the cache memory and first interface control unit,
wherein, if the first write command is received from the host computer, the first interface control unit stores the first write data related to the first write command in the cache memory via the data transfer control unit,
wherein the data transfer control unit divides the first write data stored in the cache memory into a plurality of second write data and transfers the second write data to the second interface control unit,
wherein the second interface control unit stores the second data which is transferred from the data transfer control unit in the corresponding logical block in the corresponding logical volume according to the first write command,
wherein, if the first read command is received from the host computer, the second interface control unit reads a plurality of first read data related to the first read command from the corresponding logical block in the corresponding logical volume and stores the read first read data in the cache memory via the data transfer control unit,
wherein the data transfer control unit generates second read data obtained by integrating the plurality of first read data stored in the cache memory and transfers the second read data to the first interface control unit, and
wherein the first interface control unit transmits the second read data, transferred from the data transfer control unit, to the host computer.

8. The disk array apparatus according to claim 7,
wherein the controller comprises a first interface control unit which functions as an interface during communications with the host computer;
a second interface control unit which functions as an interface during communications with the storage device unit;
a cache memory which temporarily stores data which is read/written from/to the logical volume;
a switch which switches the data transfer destination between the first interface control unit, and the cache memory and the second interface control unit; and
a processor which controls the first interface control unit, and the second interface control unit and the switch,
wherein, if the first write command is received from the host computer, the first interface control unit stores the first write data related to the first write command in the cache memory via the switch,
wherein the processor divides the first write data stored in the cache memory into a plurality of second write data and transfers the second write data to the second interface control unit via the switch,
wherein the second interface control unit stores the second data, transferred via the switch, in the corresponding logical block in the corresponding logical volume according to the first write command,
wherein, if the first read command is received from the host computer, the second interface control unit reads the plurality of first read data related to the first read command from the corresponding logical block in the corresponding logical volume and stores the read first read data in the cache memory via the switch,
wherein the processor generates second read data obtained by combining the plurality of first read data which is stored in the cache memory and transfers the second read data to the first interface control unit via the switch, and
wherein the first interface control unit transmits the second read data, transferred via the switch, to the host computer.

9. The disk array apparatus according to claim 2,
wherein the block size for handling data in the host computer is 4 kilobytes and the block size of the plurality of first storage devices is 512 bytes.

10. The disk array apparatus according to claim 1, further comprising:
a plurality of second storage devices which store data,
wherein, if a second write command is received from the host computer, the controller generates fourth write data based on third write data related to the second write command and adds a third guarantee code to the fourth write data and writes this data to the plurality of second storage devices,
wherein, if a second read command is received from the host computer, the controller reads third read data related to the second read command from the plurality of second storage devices, divides the third read data into a plurality of fourth read data, and adds a fourth guarantee code to each of the plurality of fourth data and transmits this data to the host computer.

11. The disk array apparatus according to claim 10,
wherein the block size of the third write data and the block size of the fourth read data are block sizes for handling data in the host computer and the block size of the fourth write data and the block size of the third read data are block sizes of the plurality of first storage devices.

12. The disk array apparatus according to claim 10,
wherein the controller provides a logical volume which is formed by storage area of the plurality of second storage devices to the host computer,
wherein, if a second write command is received from the host computer, when the position for writing third write data, related to the second write command in the corresponding logical block in the logical volume, does not coincide with the boundary of the logical block, the controller reads all the data in the logical block and overwrites the corresponding part among the read data with the third write data and writes back the data overwritten with the third write data to the logical block.

13. The disk array apparatus according to claim 11,
wherein the block size for handling data in the host computer is 512 bytes and the block size of the plurality of first storage devices is 4 kilobytes.

14. A control method of a disk array apparatus,
the disk array apparatus comprising a plurality of first storage devices which store data and a controller for controlling data I/O to and from the plurality of first storage devices,
the control method comprising:
a first step in which the controller receives a first write command or a first read command from a host computer; and
a second step in which the controller divides first write data related to the first write command into a plurality of second write data according to the first write command, adds the first guarantee code to each of the plurality of second write data and writes the data to the plurality of first storage devices or, according to a first read command, reads a plurality of first read data related to the first read command from the plurality of first storage devices, generates second read data obtained by combining the plurality of first read data, and adds a second guarantee code to the second read data and transmits the data to the host computer.

15. The control method of the disk array apparatus according to claim 14,
wherein the block size of the first write data and the block size of the second read data are block sizes for handling data in the host computer and the block size of the second write data and the block size of the first read data are the block sizes of the plurality of first storage devices.
